(19) United States
(12) Patent Application Publication
(10) Pub. No.: US 2014/0257904 A1
(43) Pub. Date: Sep. 11, 2014

(54) APPOINTMENT CART

(71) Applicant: Jason T. Sheiban, Strongsville, OH (US)

(72) Inventor: Jason T. Sheiban, Strongsville, OH (US)

(21) Appl. No.: 13/791,580

(22) Filed: Mar. 8, 2013

(51) Int. Cl. G06Q 30/06

(52) U.S. Cl. CPC G06Q 30/0633
USPC 705/7.19

(57) ABSTRACT

An apparatus having at least one processor is provided that provides instructions that produce a graphical user interface through a display of a client device. Such a graphical user interface may be produced by web pages viewable via a browser of the client device. Also, such a graphical user interface may correspond to the output of a software application executing on a mobile phone, tablet, or other client device. The graphical user interface includes an appointment cart to which the client device may be used to add one or more products, and subsequently schedule an appointment at a user provided date and at least one time to view in person the physical products listed in the appointment cart without providing a payment for the products.

### BACKGROUND

Web sites and software applications enable end users to purchase products from a home computer, mobile phone and other types of client devices. To assist users in finding the product that will best fit the needs of the user, many web sites for example include product reviews. Such product reviews include personal accounts of how satisfied the reviewer is with the product. Web sites may also have high resolution pictures of products and detailed lists of specifications to enable the end user to determine if the product has a desirable set of features. Such product reviews, pictures, and detailed specifications are operative to enhance the shopping experience of the user. It should be appreciated that systems and software applications that facilitate the purchase of products may benefit from further improvements that enhance the shopping experience of the user.

### SUMMARY

The following is a brief summary of subject matter that is described in greater detail herein. This summary is not intended to be limiting as to the scope of the claims.

In one example embodiment of one or more inventions described herein, a web site or a software application that enables users to view products, may further include an appointment cart. The user may add one or more products to the appointment cart, and may subsequently schedule an appointment to view in person the physical products listed in the appointment cart prior to purchasing one of the products.

This described embodiment may include the form of an apparatus (and/or system) that comprises at least one processor that is operative to communicate with at least one client device and at least one data store. Such at least one processor for example may be included in a web server and may be operative to communicate with web pages through the Internet with a browser or other software application of a client device such as a personal computer, mobile phone, or other personal electronic device. The client device may include a display device (e.g., monitor, touch screen) and at least one input device (e.g., mouse, keyboard, keypad, touch screen) capable of being operated by a user. However, it should also be appreciated that this described at least one processor may alternatively correspond to one or more of the processors included in the client device which is configured with a software application having functionality similar to that of a browser displaying web page provided by the web server.

The at least one processor may be operatively configured to provide instructions for the at least one client device that cause the at least one client device to output through the display device a graphical user interface (e.g. a visual output that allows users to interact with the client device using images and visual objects). In the web server example, such instructions for example may correspond to web pages including HTML, JavaScript and/or any other instructions which enable the browser of the client device to produce the graphical user interface described herein. Also, in a client device software application example, such instructions may correspond to the video graphics signals generated by one or more processors (such as a graphics processor) of the client device responsive to the software application, which signals cause the display device of the client to output the graphical user interface.

The graphical user interface may display a list of a plurality of products that can be individually selected through operation of the at least one input device of the at least one client device. In addition, the graphical user interface may simultaneously display one or more cart adding selectable options (e.g. visual buttons, menu items, hypertext links). Such cart adding selectable options may include at least an appointment cart selectable option. Also, it should be appreciated that in some example embodiments, the cart adding selectable options may include both the appointment cart selectable option and a shopping cart selectable option. Also, in some example embodiments, the cart adding selectable options may include the appointment cart selectable option, but may not include a shopping cart selectable option.

For appointments, the at least one processor is operative responsive at least in part to selections of one or more products from the list of products and is responsive at least in part to at least one selection of the appointment cart selectable option through operation of the at least one input device, to cause data representative of the one or more selected products to be added to an appointment cart list stored in the at least one data store. Such a data store may correspond to a database, file, memory, server, service, or other data storing component with which software operating in the web server or client device is operative to store data therein to facilitate storing products in the appointment cart list.

In an example embodiment, the at least one processor is operatively configured to provide instructions for the at least one client device that cause the at least one client device to cause the graphical user interface to display both data representative of each of the products stored in the appointment cart list and a schedule appointment selectable option (e.g. a graphical button or a hypertext link). The at least one processor is operative responsive at least in part to a selection of the schedule appointment selectable option to provide instructions for the at least one client device that cause the at least one client device to cause the graphical user interface to display a plurality of graphical user interface elements with which scheduling data is selectable through operation of the at least one input device.

Such graphical user interface elements may include text boxes, drop down list boxes, check boxes, and/or any other graphical user interface control that enables a user to provide data useful for scheduling the appointment. Such data may include then name and contact information of the user as well as a selected date and at least one time to schedule the appointment.

The at least one processor is operative responsive at least in part to selections of scheduling data through operation of the at least one input device to cause an appointment to be scheduled to view in-person each of the products included in the appointment cart list. To schedule the appointment, the at least one processor may cause data representative of the appointment to be communicated to a vendor that provides the selected products. Such data representative of the appointment may include the scheduling data and a listing of each of the products included in the appointment cart list. Such scheduling data included in the communicated data representative of the appointment may include data representative of the name of the user as well as the selected date and the at least one time of the appointment.

For example embodiments that include both an appointment cart and a shopping cart, the at least one processor may be operative responsive at least in part to selections of one or more products from the list of products and may be responsive at least in part to at least one selection of the shopping cart selectable option through operation of the at least one input device, to cause data representative of the selected one or more products to be added to a shopping cart list stored in the at least one data store. The at least one processor may also be operative to cause payment data (e.g., billing information, credit card information) to be associated with the products included in the shopping cart list.

Other aspects will be appreciated upon reading and understanding the attached figures and description.

### BRIEF DESCRIPTION OF THE DRAWINGS

FIG. 1 is a functional block diagram of an example system that facilitates producing a graphical user interface that provides an appointment cart for a plurality of products.

FIGS. 2-7 illustrate an example of the graphical user interface in the form of web pages.

FIG. 8 is a functional block diagram of another example system that facilitates producing a graphical user interface that provides an appointment cart for a plurality of products.

FIG. 9 is a flow diagram that illustrates an example methodology that facilitates producing a graphical user interface that provides an appointment cart for a plurality of products.

### DETAILED DESCRIPTION

Various technologies pertaining to systems and methods associated with products for sale via use of an on-line server will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

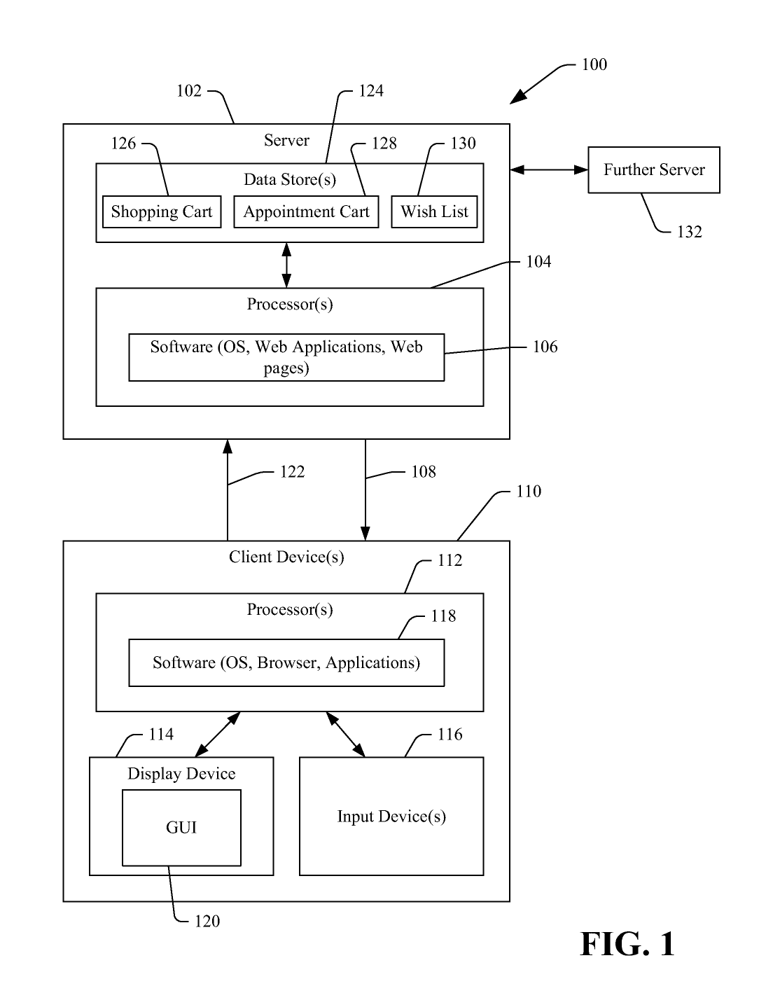

With reference to FIG. 1, an example apparatus and/or system 100 that facilitates producing a graphical user interface that provides an appointment cart for a plurality of products, is illustrated. In this example, the system 100 may include at least one server 102 such as a web server. The server 102 may include at least one processor 104 that is operative to execute software components 106 that cause the processor 104 to carry out features of the system that are described herein. In example embodiments, the software components may include an operating system, web server applications, web pages, and/or any other software components that enable the server 102 to operate. Also, it should be appreciated that the described at least one processor 104 may include one or more virtual processors associated with virtual machines operating in the physical processors of the server 102. Each virtual machine may include its own respective operating system and software components executing in a virtual processor in order to carry out features of the system that are described herein.

In this described example, the at least one processor 104 of the server 102 is operative to provide instructions 108 to one or more client devices 110. Client devices for example may correspond to personal computers (PCs), desktops, laptops, tablets, mobile phones, and/or any other type of device with which an end user may access the server 102 through a wired and/or wireless network. The server 102 for example may be operative to communicate instructions 108 through a network such as the Internet to the client devices 110.

A client device may include at least one processor 112. In addition, the client device may include a display device 114 (e.g., an LCD, OLED, or other type of display screen) in operative connection with the processor 112. Also, the client device may include one or more input devices 116 (e.g., touch screen, mouse, keyboard, keypad) in operative connection with the processor 112. Further, the client device 110 may include a plurality of software components 118, which may include an operating system, browser, and a plurality of software applications.

In an example in which the server 102 corresponds to a web server, the instructions 108 may correspond to web pages that include markup language instructions and/or programming instructions (e.g., HTML, HTML5, XML, JavaScript). Such instructions are operative to cause the processor 112 operating in the client device to cause the display device to output a graphical user interface 120. For example, the client device may include a browser (or other software component) executing in the processor 112 of the client device, which browser is operative responsive at least in part to the instructions 108 from the server to cause a web page based graphical user interface 120 to be outputted through the display device 114. The browser (executing in the processor of the client device 110) may further be operative responsive to inputs received through operation of the input devices 116 to select information and/or selectable options displayed by the graphical user interface. In addition, the browser executing in the processor of the client device 110 may be operative to receive information (e.g. text, numbers) inputted through operation of the input devices.

In an example embodiment, the browser may be operative to send at least one communication 122 to the server 102, which communication includes data representative of the inputted information, selected information and/or selected options associated with the graphical user interface. The server may be operative to process the information received in the communications 122, to cause instructions 108 to be sent to the client device, which cause the graphical user interface to be updated and/or to display different information.

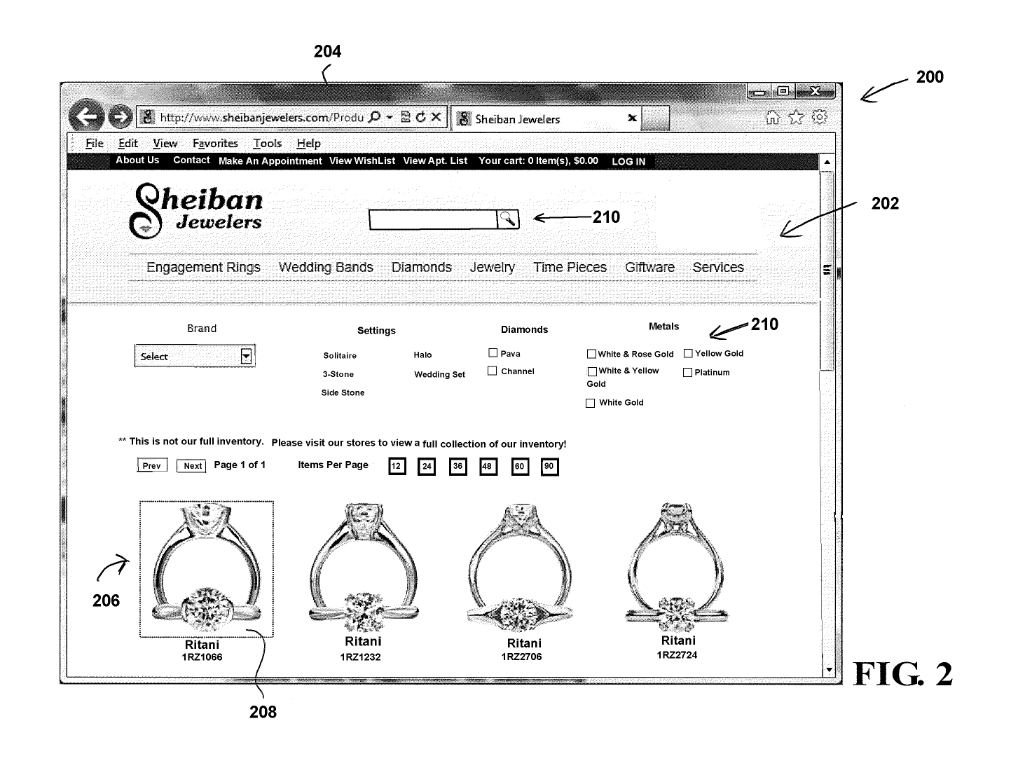

FIG. 2 shows an example 200 of a graphical user interface 202 in the form of a web page displayed via a browser 204 operating in a client device. The web page 202 displays a plurality of images of products 206 provided by a vendor. The web page may provide graphical user interface elements 210 (e.g. search text boxes, filter check boxes, and dropdown lists of types of products) for filtering and/or searching for a sub-set of products to display that may be available from a vendor.

In this example the displayed products correspond to jewelry such as rings being sold by a vendor such as a jeweler or other businesses entity. However, it should be appreciated that the embodiments described herein may be applicable to any type of products or services that are capable of being displayed in a graphical user interface and that may be desirable to view in-person at a scheduled appointment prior to selecting and purchasing one of the products. Other examples of products may include wedding dresses, tuxes (or other clothing), watches, collectibles, vehicles, and/or any other product that may have qualities which are useful to evaluate in-person prior to purchasing (or renting).

In the example web page 202 shown in FIG. 2, the web page is constructed such that each product may be selected through operation of an input device of the client (e.g. a mouse, or a touch screen). In this example, selecting (e.g., clicking via a mouse or touch screen) an image 208 of one of the products is operative to cause the graphical user interface (via operation of the browser communicating with the server) to display a further web page that provides additional details of the selected product.

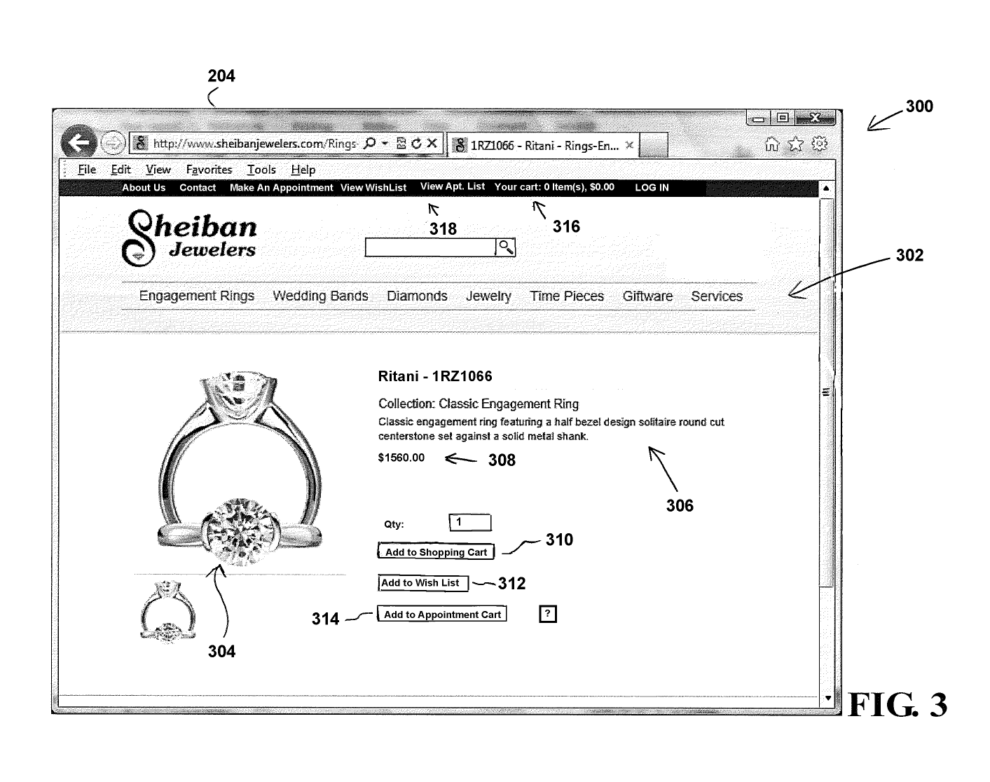

FIG. 3 illustrates an example 300 of such a further web page 302. In this example, the web page includes a relatively larger image 304 of the selected product as well as a relatively more detailed textual description 306 of the product. In addition, the web page 302 may include a price 308 of the product.

To enable the user of the web site to select multiple products at one time for purposes of scheduling an appointment to view the selected products, the graphical user interface may include a selectable option to enable the user to add the product to an appointment cart list. Also, in this described example, to enable the user of the web site to purchase multiple products at one time, the graphical user interface may include a selectable option to enable the user to add the product to a shopping cart list. Also, it should be appreciated that in alternative embodiments, an example graphical user interface may only include the selectable option to add products to an appointment cart list and not a shopping cart list. However, for purposes of explaining the different functionally associated with each type of cart, the following example shows both a shopping cart and an appointment cart.

As shown in FIG. 3, a shopping cart selectable option may have the form of a graphical button 310 which includes descriptive text such as “Add to Shopping Cart”. However, it should be appreciated that in alternative embodiments other text or other types of graphical user interface selectable elements may be used. For example, alternative text may include “Place in Shopping Cart”. Also an alternative form of the selectable option may be a hypertext link.

In this example, clicking on the location of the graphical button 310 (via a mouse, touch screen or other input device) is operative to cause the browser to communicate the action to add the selected product to a shopping cart via a communication 122 to the server 102 (See FIG. 1). The server is operative responsive to the communication 122 to cause data representative of the selected product to be added to a shopping cart list 126 stored in one or more tables in at least one data store 124 (for the particular user session of the particular client device). Such a data store 124 may correspond to a database software component with a plurality of tables that are operative to organize and store information related to a user's interaction with the web site. An example table that stores a shopping cart list 128 for example, may be operative to associate a session ID for a particular set of web pages displayed by a client device with a plurality of product IDs representative of the products selected by the user using the graphical user interface.

In an example embodiment, such a data store 124 may be operative to execute in the same server as the web server software components that are used to generate the instructions for the various web pages of the described graphical user interface. However, it should be appreciated that in alternative embodiments, the data store 124 may execute in a different server (or a different virtual machine in the same server or a different server). Also, it should be appreciated that the data store 124 may have other forms, including one or more variable arrays stored in the memory of a web site application, and/or any other type of software, file, memory, server, service, and/or storage component that is operative to store information associated with the operation of the web site provided by the server 102.

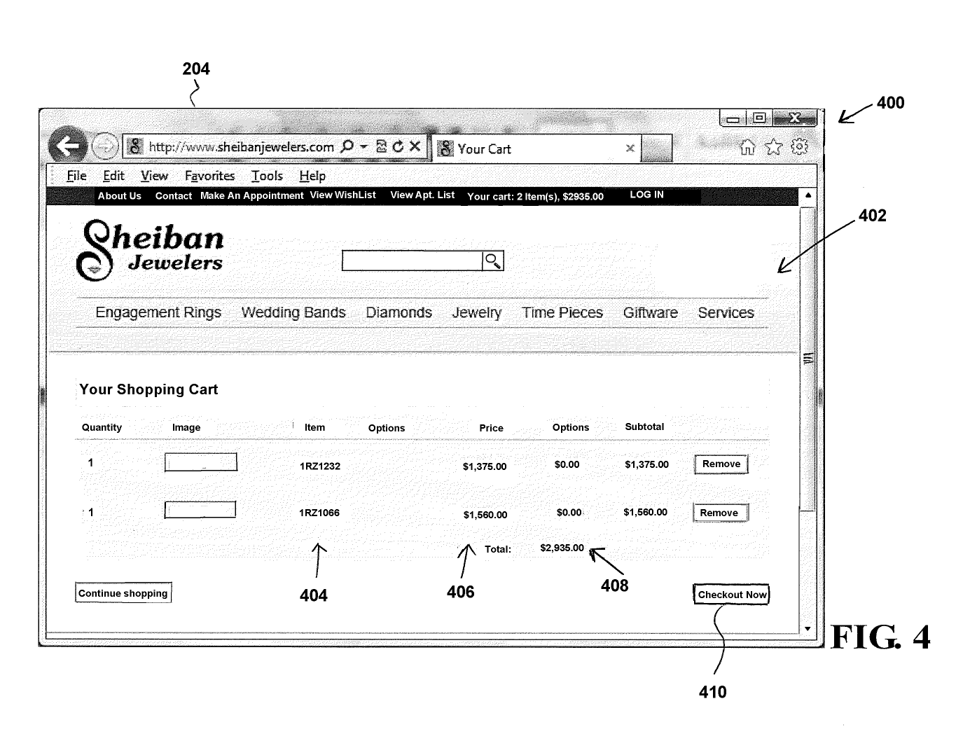

In one example embodiment, when a user selects the shopping cart selectable option 310, (in addition to adding the product to a shopping cart list stored in a data store) the web server 102 is further operative to cause the graphical user interface to display information that shows the addition of the product to the shopping cart list. For example, the web server may communicate instructions to the client device which cause the client device to display a further web page that shows the contents of the shopping cart list. FIG. 4 illustrates an example 400 of such a web page 402. In this example, the shopping cart list is shown after a second product has been added to the shopping cart list. Thus the web page 402 shows two products 404, their respective prices 406 and a total 408 of the prices for the products included in the shopping cart list.

In this example, the shopping cart web page 402 may also display a selectable option 410 (e.g., a graphical button) that may be selected through operation of an input device of the client. Such a further selectable option 410 may correspond to a command to check out and carry out the steps needed to provide a payment for the products in the shopping cart list. Such a selectable option may include a textual description such as “Checkout Now” or other text or graphical symbol which conveys that the action to commence the purchase of the products.

When the selectable option 410 is selected for example, the browser may send a communication to the server that causes the server to provide instructions (e.g. further web pages) that enable a user using the client device to provide the server with shipping address information and payment information (e.g., via credit card data, debit card data, gift card data, gift certificate data, PayPal account data, or other payment method information). In further embodiments, the further web pages may provide a mechanism and/or information usable to pay via an electronic transfer of value via a wire-transfer, Bitcoin transfer, Litecoin transfer, and/or any other form of a transfer of electronic value or money.

The described server may be operative responsive to the products listed in the shopping cart list, the shipping information, and the payment information to cause a financial account associated with the payment information to be assessed the cost of the products in the shopping cart list and any applicable sales taxes, and shipping and handling charges. In addition, the described server may be operative responsive to the products listed in the shopping cart list, the shipping address information, and the payment information to cause the products listed in the shopping cart list to be packaged in at least one box and to be delivered to a postal address associated with the shipping address information.

Also, it should be appreciated that an example graphical user interface may include one or more other selectable options to view products stored in the example shopping cart list. For example as illustrated in FIG. 3, the web page 302 may include a selectable option in the form of a selectable menu item 316 at the top of the web page, which when selected (via an input device of the client device) is operative to cause that contents of a shopping cart list (such as shown in FIG. 4) to be displayed.

As illustrated in FIG. 3, in addition to a shopping cart selectable option 310, an example graphical user interface may also display an appointment cart selectable option 314. In a typical example, when a particular product web page is being displayed (such as shown in FIG. 3) the web page may show both the shopping cart selectable option 310 and the appointment cart selectable option 314, such that both are simultaneously viewable on the display device of a client device by a user. Having both options available enables the user to select either option in order to add the displayed product 304 to the shopping cart list 126 and/or the appointment cart list 128 stored in the data store 124.

In an example embodiment, the appointment cart selectable option 314 enables the user of the web site to select multiple products at one time for purposes of scheduling an appointment to view the selected products prior to purchasing one or more of them. As shown in FIG. 3, such an appointment cart selectable option 314 may have the form of a graphical button 312 which includes descriptive text such as “Add to Appointment Cart”. However, it should be appreciated that in alternative embodiments other text or other types of graphical user interface selectable elements may be used. For example, alternative text may include “Place in Appointment Cart”. Also an alternative form of the selectable option may be a hypertext link.

In this example, clicking on the location of the graphical button 314 (via a mouse, touch screen or other input device) is operative to cause the browser to communicate the action to add the selected product to the appointment cart via a communication 122 to the server 102. As shown in FIG. 1, the server is operative responsive to the communication 122 to cause data representative of the selected product to be added to an appointment cart list 128 stored in one or more tables in the at least one data store 124 (for the particular user session of the particular client device). An example table that stores an appointment cart list 128 for example may be operative to associate a session ID for a particular set of web pages displayed by a client device with a plurality of product IDs representative of the products selected by the user using the graphical user interface.

It should be appreciated that the server may be in communication with a plurality of client devices, each corresponding to a discrete and separate session ID. The at least one server is operative to store a different appointment cart list (and/or a shopping cart list) in the data store 124 for each of the different sessions/client devices.

In one example embodiment, when a user selects the appointment cart selectable option 314, (in addition to adding the product to an appointment cart list stored in a data store) the server 102 is further operative to cause the graphical user interface to display information that shows the addition of the product to the appointment cart list. For example, the web server may communicate instructions to the client device which cause the client device to display a further web page that shows the contents of the appointment cart list.

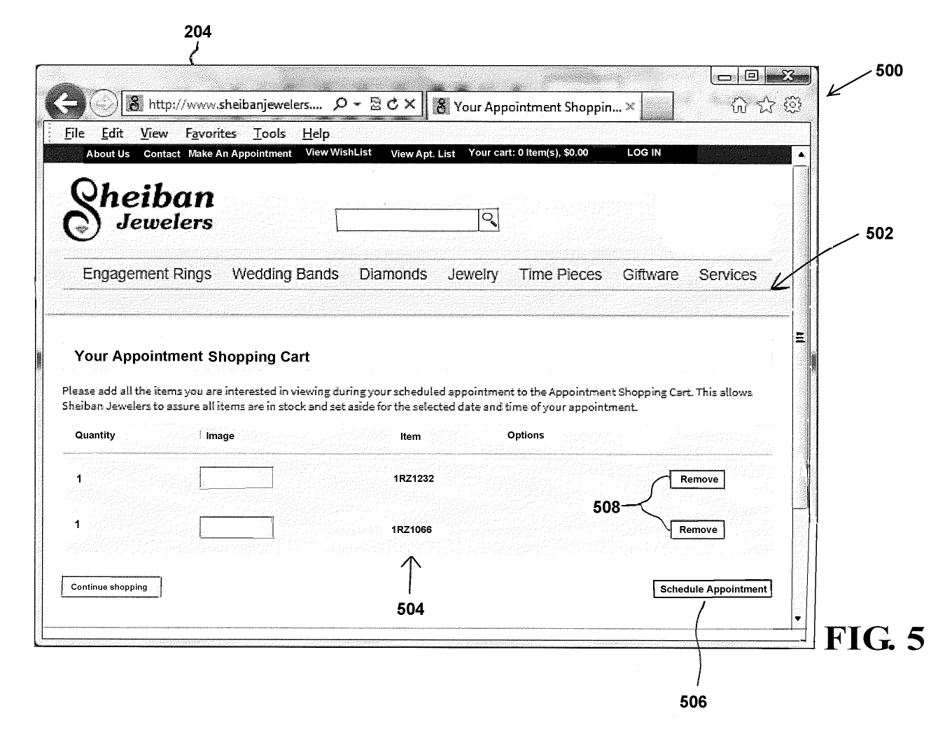

FIG. 5 illustrates an example 500 of such a web page 502. In this example, the contents of the appointment cart list are shown after a second product has been added to the appointment cart list. Thus the web page 502 shows two products 504 included in the appointment cart list.

In this example, the appointment cart web page 502 may also display a selectable option 506 (e.g., a graphical button) that may be selected through operation of an input device of the client device. Such a selectable option 506 may correspond to a command to schedule an appointment to view the products in the appointment cart list. When the selectable option 506 is selected for example, the browser may send a communication to the server that causes the server to provide further instructions (e.g. a web page) that enable a user using the client device to provide scheduling information. Such a selectable option 506 may have a textual label such as “Schedule Appointment” or other text or graphical symbol that conveys to a user that the selection of the selectable option 506 will begin the process of generating a schedule to view the products listed in the appointment cart list.

In addition, the appointment cart web page 502 may also include a selectable option 508 for each of the listed products 504, which is selectable to cause the server to remove the corresponding product from the appointment cart list stored in the data store. In an example embodiment, the selectable options 508 may have textual labels such as “Remove”, a symbol of a trash can, or any other text or graphical symbol that conveys to a user that the selection of one of the selectable options 508 will remove the respective product from the appointment cart list.

Also, it should be appreciated that an example graphical user interface may include one or more other selectable options to cause the graphical user interface to display a list of the products stored in the appointment cart list. For example as illustrated in FIG. 3, the web page 302 may include a selectable option in the form of a selectable menu item 318 at the top of the web page, which when selected (via an input device of the client) is operative to cause the contents of an appointment cart list (such as shown in FIG. 5) to be displayed.

Referring back to FIG. 5, when the selectable option 506 (e.g. labeled “Schedule Appointment”) is selected through operation of an input device of the client device, the server is operative to cause instructions to be communicated to the client device which cause the client device to display a further web page with which a user may provide scheduling data.

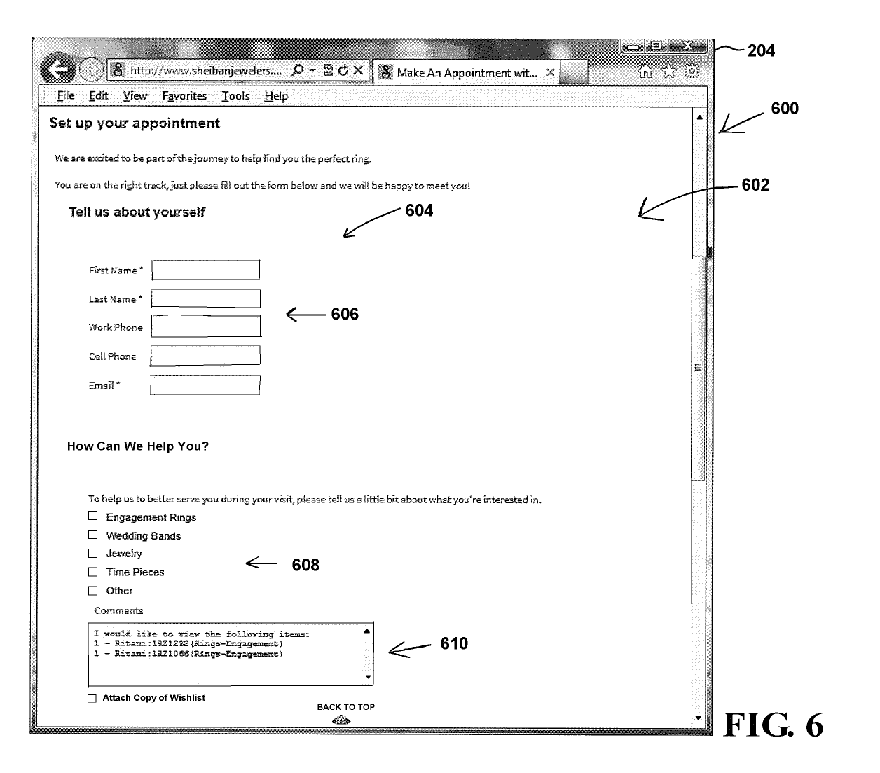

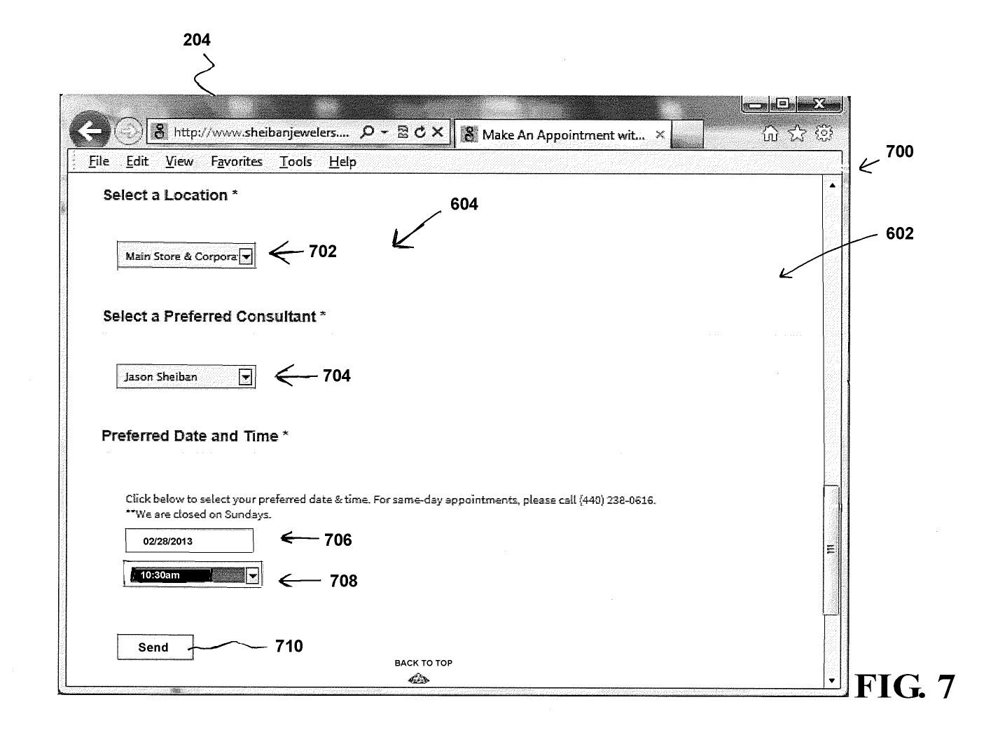

FIGS. 6 and 7 illustrate an example of such a web page 602. FIG. 6 shows an upper portion 600 of the web page 602 and FIG. 7 shows a lower portion 700 of the web page 602. In this example, the web page displays a plurality of graphical user interface elements 604 with which scheduling data is provided through operation of an input device of the client device. Examples of scheduling data may include: at least one date and time for the appointment to take place (which may include a range of dates and/or times); user identifying data (e.g. the name, username, and/or contact information for the user scheduling the appointment); a desired name of a person such as a sales person or consultant for the user to meet at the appointment; a location of the appointment; information that describes what the user may be interested in purchasing; and/or any other data that would be helpful to schedule an appointment.

To provide this information, the graphical user interface may include graphical user interface elements 604 in the form of edit boxes, check boxes, selection fields, drop down lists, drop down calendars, and/or any other graphical user interface element that can be manipulated through operation of an input device of the client device. For example as shown in FIG. 6, the web page 602 may include edit boxes 606 in which a user may provide: user identifying data such as a first name, last name, work phone, cell phone, e-mail address, and/or any other contact information. For example, an alternative embodiment may also include edit boxes to provide a mailing address.

In addition, the web page 602 may include check boxes 608 that enable a user to select different categories of products that the user may be interested in viewing. For example, in a web site for a jeweler, such categories may include check boxes to select product categories such as: engagement rings; wedding bands, jewelry, time pieces, and other products.

In addition, as shown in FIG. 7, the web page 602 may include a drop down list box 702 that displays a selection of different locations (e.g., vendor stores) at which the appointment can be scheduled. Also the web page 602 may include a drop down list box 704 that displays a listing of sale people, consultants, managers and/or other representatives of the vendor that are available to meet with the user. In addition, the web page 602 may include a date entry selection box 706, which when selected is operative to provide a popup calendar (or other type of graphical user interface control) with which a day/month/year for a date can be selected. Further, the web page 602 may include a time selection field (e.g., such as a drop down list box) 708 that displays a selection of time data for meeting times at which the appointment can be scheduled. Such time data may correspond to a particular hour and minute to begin the appointment. Also such time data may also include a range of times (e.g. 9:00 am to 10:00 am). Also, such time data may include a time period (e.g., morning, afternoon, evening).

In an example embodiment, the web server may be operative to provide data for the selections (e.g. sales people, store locations) from data stored in the data store associated with the web server. The web server may be operative to generate the instructions that cause the web page 602 to be generated responsive to the selection data stored in the data store. However, it should also be appreciated that the web server may be operative to populate the selections in the web page 602 responsive to dynamically changing and/or selected data.

For example, the server may be operative to provide a selection of locations in the drop down list box 702 responsive at least in part on the particular products included in the appointment cart list. For example, the data store may include a listing of products for a plurality of stores to enable the server to populate the drop down list box 702 with stores that can show in-person the selected products in the appointment cart list. However, it should be appreciated that if needed the vendor that operates the described web site may be operative (responsive to a selected location) to move products between store locations in order to ensure that the selected products are physically at the location selected by the user.

Also for example, the server may be operative to provide a selection of sales persons in the drop down list box 704 responsive at least in part on the particular employees that work at the selected location in the drop down list box 702. In addition, the server may be operative to provide a selection of sales persons in the drop down list box 704 responsive at least in part to the selected location and the date and time data selected by the user with the graphical user interface elements 706, 708. For example, the server may be in operative connection with a data store and/or another server (such as a calendar server) that includes the work schedules and/or places of work of sales people. Thus, the persons included in the drop down list box 704 may only include individuals that are available at the particular store location, and date/time selected by the user of the web page 602.

In another example, the server may be operative to provide a selection of dates and times with the graphical user interface elements 706, 708 responsive at least in part to the particular sales person selected with the drop down list box 704 and/or the location selected with the drop down list box 702. In this example, the server may be responsive to calendar data associated with a calendar of the selected sales person (which shows the days and times that the sales person is available for appointments) and/or a calendar of the selected store location (which shows the days and hours that the selected store is available for appointments) to generate a selection of dates and times that correspond to when the selected employee and store location are available for appointments. In such examples, the calendar data may be stored in a data store executing in the web server. However, it should be appreciated that the data store from which the calendar data is accessed may correspond to a calendar sever. The web server for example may access calendar data from the calendar server using Caldav, ActiveSync or other calendar protocol/system.

In addition, it should be appreciated that the vendor that operates the described web site may be operative (responsive to a selected location, date, time, and sales person) to instruct the sales person to be available at the selected location at the date and time selected by the user for the appointment. If there is a problem with the availability of the products in the appointment cart list and/or the availability of the sales person, the contact information provided by the user may be used by the vendor to contact the user to schedule a different location, sales person, date, and/or time to meet with the user.

As shown in FIG. 7, the web page 602 may include a selectable option 710 (e.g., a graphical button) that may be selected through operation of an input device of the client. The selectable option 710 may correspond to a command to cause the scheduling data (provided via the web page 602) to be communicated to the web server. In response to such a communication, the server 102 (shown in FIG. 1) may be operative to cause the scheduling data to be stored in the data store 124 in association with a list of the products included in the appointment cart list. Such data stored in the data store may be accessed via a web interface, point of sale terminal, or other interface in order to ensure that the selected products and selected sales person are available at the selected location at the selected date and time included in the scheduling data.

However, rather than or in addition to storing the scheduling data and associated products from the appointment cart list in a data store with which the server is operative to manage, the server 102 may be operative to communicate data representative of the appointment to a further server 132 (shown in FIG. 1). Such a further server 132 may correspond to an e-mail server, a host system for point of sale terminals, a calendar server, or any other type of server that is operative to communicate the appointment data to the vendor providing the products. Such appointment data may include the previously described scheduling data and a list of products included in the appointment cart list.

For example, the server 102 may be operative to send an e-mail to an e-mail address of a designated individual such as a designated sales manager that is operative to handle the scheduling of appointments. In addition, or alternatively, the server may send an e-mail including the appointment data to the e-mail address of the particular selected sales person included in the scheduling data.

In another example, the server may be operative to interface with a calendar server (e.g., Microsoft Exchange, VMware Zimbra, Google Calendar, or other calendar or groupware server/service) using calendar/groupware protocols such as ActiveSync and Caldav to cause an appointment to be scheduled on a calendar of one or more individuals associated with the vendor for the selected products.

In a further example, the server may be operative to communicate with a host system that manages the operation of a plurality of point of sale terminals located at the store(s) of the vendor. When a selected sales person (included in the appointment data) logs into a point of sale terminal, the host system may be operative to cause the point of sale terminal to display details of the appointment such as the name of the user that scheduled the appointment, the products to view, and the date and time of the appointment.

It is to be understood that the functionality of the described server to cause appointment data to be communicated to a provider of the plurality of products, may correspond to storing appointment data in a data store, which can be accessed by the provider (via a web interface, point of sale terminal, or other device), and/or may correspond to sending a message (e.g., an e-mail) including the appointment data to an address of the provider (e.g., or a server of the provider such as an e-mail server, calendar server, or a host system).

In response to receiving a communication of an appointment, an employee of the vendor of the products may be operative to pull from an inventory of the vendor each of the products included in the appointment data. Further, based on the types and styles of the products selected by the user and any interest data included in the appointment data, the employee of the vendor may select additional products that may be of interest to the user.

Referring back to FIGS. 6 and 7, it should be appreciated that data displayed in the web page 602 may correspond to an example of appointment data that is communicated to the vendor (e.g. via storage in a data store and/or communication to e-mail or other server). In this example, the web page 602 also includes an editable text box 610, which includes textual descriptions of the selected products included in the appointment cart list stored in the data store. In this example, the user may further update the text box by deleting products and or adding additional comments regarding the interests of the user at the appointment. In an example in which an e-mail is communicated to the vendor with the appointment data, textual forms of the data shown in FIGS. 6 and 7 may be concatenated together and included in the body of the e-mail message.

Referring back to FIG. 3, in addition to an appointment cart selectable option 314, an example graphical user interface may also simultaneously display a wish list selectable option 312 (e.g. a button or hypertext link) in addition to or in place of the shopping cart selectable option 310. Such a wish list selectable option, when selected, causes data representative of a selected product to be stored in a wish list 130 in the data store 114 in association with a user account also stored in one or more tables of the data store. When a user logs into the web site with a user login ID and password associated with the user account, the web server may enable the user to view a web page that lists all of the products added to the wish list 130 associated with the account.

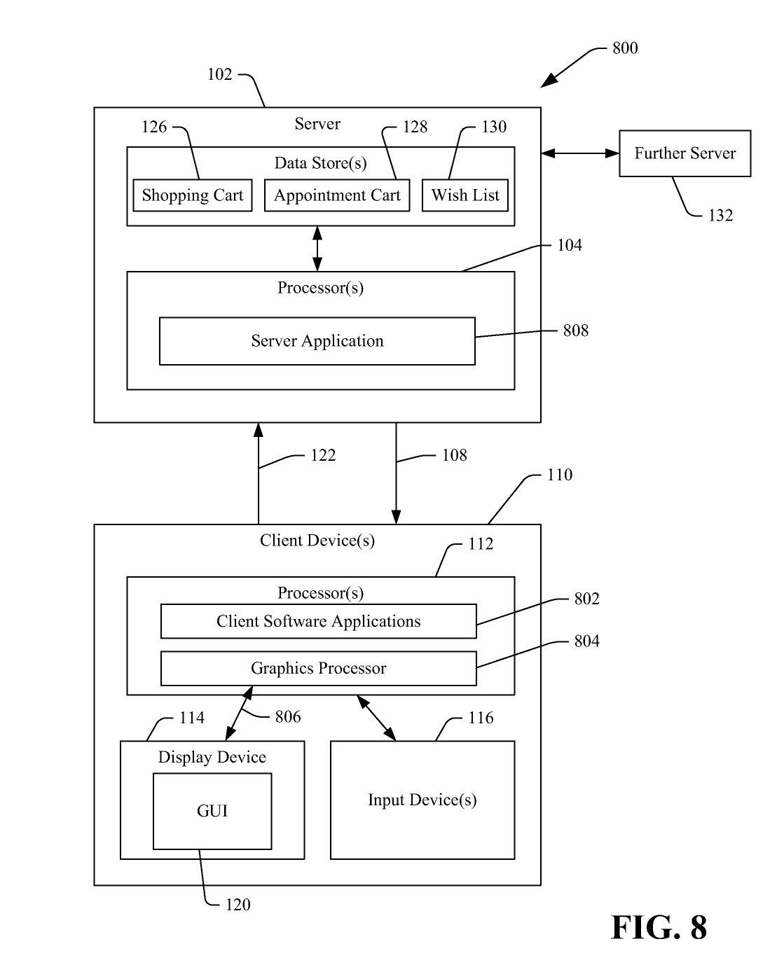

FIGS. 2-7 illustrate examples of a graphical user interface in the form of web pages. However, it should be appreciated that alternative embodiments may include other forms of graphical user interfaces. For example, FIG. 8 illustrates an example apparatus/system 800 in which the graphical user interface is provided by a dedicated software application 802 (rather than a general purpose browser) operating in the at least one processor 112 of the client device 110. Such a dedicated software application 802 for example, may correspond to a downloadable application that is downloaded and installed on a mobile phone or tablet from a cloud based market place, application store, or other online application provider.

In this example the at least one processor 112 is operative responsive to the software application 802 to cause instructions to be provided for the client device that cause a display device 114 of the client device to output the graphical user interface 120. In this example, the at least one processor may include a graphics processor 804 that is operative to output instructions 806 in the form of video graphics signals to the display device 120.

In this example, the software application may be operative to provide a plurality of screens including elements that correspond to the previously described selectable options and graphical user interface elements of the web pages shown in FIGS. 2-7. In addition, the software application may interface with a remote server 102. In this example, the remote server may or may not correspond to a web server. For example, the server 102 may include a dedicated server application 808 that is operative to provide data necessary to the operation of the software application 802 on a plurality of client devices 110. For example, the server application 808 may provide data in an XML format representative of lists of products, data representative products added to a shopping cart list, data representative of products added to an appointment cart list, and data usable to schedule appointments (e.g. locations, sales persons, and available dates/times). The software application 802 in the client device may be responsive to such data received from the server to generate the described graphical user interface. Further, the described software application 802 in the client device may be operative to communicate the searches, queries, product selections, commands to add a product to a shopping list and an appointment list, scheduling data, and/or any other data and commands to the server that are needed to facilitate operation of the scheduling application, purchasing products in a shopping cart list, and the scheduling of an appointment to view products in an appointment cart list.

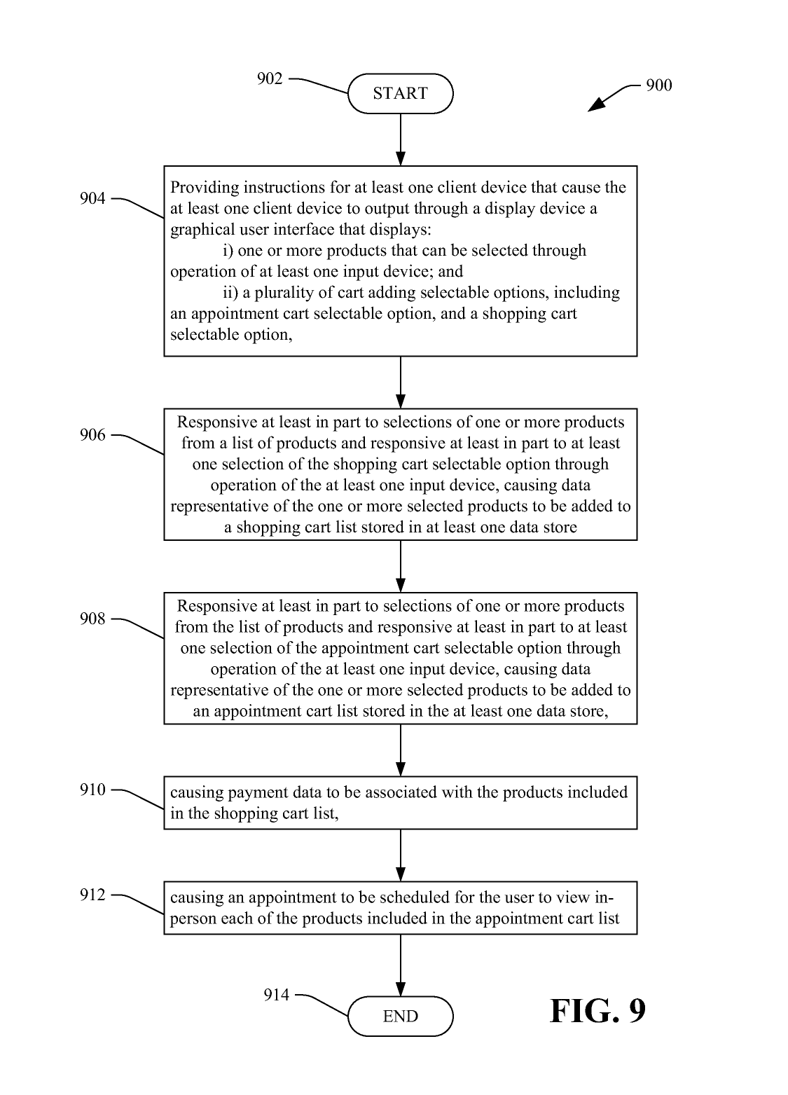

With reference now to FIG. 9, an example methodology is illustrated and described associated with the operation of the example systems described herein. While the methodology is described as being a series of acts or steps that are performed in a sequence, it is to be understood that the methodology are not limited by the order of the sequence. For instance, some steps may occur in a different order than what is described herein. In addition, a step may occur concurrently with another step. Furthermore, in some instances, not all steps may be required to implement a methodology described herein.

Moreover, the steps described herein may implemented by non-transitory computer-executable instructions that can be implemented by one or more processors and/or stored on a computer-readable medium or media (e.g., hard drives, SSDs, flash memory, CDs, DVDs). The computer-executable instructions may include a routine, a sub-routine, programs, a thread of execution, and/or the like. Still further, results of steps of the methodologies may be stored in a computer-readable medium, displayed on a display device, and/or the like.

Referring now to FIG. 9, the methodology 900 illustrates an example of steps that facilitates producing a graphical user interface that provides both an appointment cart and a shopping cart and for a plurality of products. However, it should be appreciated that in examples that only include an appointment cart and not a shopping cart, the shopping cart related steps and features, may not be carried out.

The methodology 900 begins at 902, and at step 904 may include through operation of at least one processor (in a server and/or client device), providing instructions for the at least one client device that cause the at least one client device to output a graphical user interface through a display device. As discussed previously, the outputted graphical user interface includes indicia (text/images) representative of a plurality of products that can be selected through operation of at least one input device of at least one client device. In addition, the outputted graphical user interface displays at least one cart adding selectable options (e.g., graphical buttons, links), including an appointment cart selectable option and (optionally) a shopping cart selectable option.

At step 906 the described methodology 900 may include through operation of at least one processor responsive at least in part to selections of one or more products from the list of products and responsive at least in part to at least one selection of the shopping cart selectable option through operation of the at least one input device, causing data representative of the selected products to be added to a shopping cart list stored in at least one data store. In addition at step 908, the described methodology 900 may include through operation of at least one processor responsive at least in part to selections of one or more products from the list of products and responsive at least in part to at least one selection of the appointment cart selectable option through operation of the at least one input device, causing data representative of the selected products to be added to an appointment cart list stored in the at least one data store.

Further at step 910, the described methodology 900 may include through operation of at least one processor, causing payment data to be associated with the products included in the shopping cart list. Also, at step 912 the described methodology 900 may include through operation of at least one processor, causing an appointment to be scheduled for the user to view in-person each of the products included in the appointment cart list on data and at least one time selected by the user. At 914 the described methodology may end.

This described methodology may carry out causing an appointment to be scheduled in different ways. For example, the methodology 900 may further include through operation of at least one processor, receiving data representative of a date and at least one time of the scheduled appointment as well user identifying data such as a name of a user and contact information. In one example, step 912 may include through operation of at least one processor causing an e-mail message to be sent through at least one e-mail server, which e-mail message includes the data representative of the date and at least one time of the scheduled appointment, the user's name, contact information, and a listing of each of the products included in the appointment cart list.

In another example, step 912 may include through operation of the at least one processor, causing at least one point of sale terminal to display the data representative of the date and at least one time of the scheduled appointment, the user's name, contact information, and a listing of each of the products included in the appointment cart list. In yet another example, step 912 may include through operation of the at least one processor, causing a calendar server to store the appointment for the date and at least one time included in the appointment data as well as notes that include a listing of each of the products included in the appointment cart list and the user's name, contact information.

It should also be appreciated that the described methodologies may include steps corresponding to one or more of the features and functions described as being carried out by one or more of the example systems described herein. Additionally, it should be appreciated that the described systems may correspond to a distributed system. Thus, for instance, several devices, servers, data stores, and/or other components may be in communication by way of a network connection and may collectively perform tasks described as being performed by one or more of the described devices, servers, data stores, and/or other components.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. An apparatus comprising:
at least one processor that is operative to communicate with at least one client device and at least one data store,
wherein the at least one client device includes a display device and at least one input device capable of being operated by a user,
wherein the at least one processor is operatively configured to provide instructions for the at least one client device that cause the at least one client device to output through the display device a graphical user interface,
wherein the graphical user interface displays one or more products that can be selected through operation of the at least one input device of the at least one client device,
wherein the graphical user interface displays at least one cart adding selectable option, including an appointment cart selectable option,
wherein the at least one processor is operative responsive at least in part to selections of one or more products and is responsive at least in part to at least one selection of the appointment cart selectable option through operation of the at least one input device, to cause data representative of the selected one or more products to be added to an appointment cart list stored in the at least one data store,
wherein the at least one processor is operatively configured to provide instructions for the at least one client device that cause the at least one client device to cause the graphical user interface to display both data representative of each of the products stored in the appointment cart list and a schedule appointment selectable option,
wherein the at least one processor is operative responsive at least in part to a selection of the schedule appointment selectable option to provide instructions for the at least one client device that cause the at least one client device to cause the graphical user interface to display a plurality of graphical user interface elements with which scheduling data is provided through operation of the at least one input device,
wherein the at least one processor is operative responsive at least in part to provided scheduling data through operation of the at least one input device to cause an appointment to be scheduled to view in-person each of the products included in the appointment cart list, including causing data representative of the appointment to be communicated to a vendor that provides the selected products, which data representative of the appointment includes the scheduling data and a listing of each of the products included in the appointment cart list, wherein the provided scheduling data included in the communicated data representative of the appointment includes data representative of a date and at least one time of the appointment and user identifying data.

2. The apparatus according to claim 1, further comprising at least one server and the at least one data store, wherein the at least one server is in operative connection with the at least one data store, wherein the at least one server includes the at least one processor.

3. The apparatus according to claim 2, wherein the at least one server includes a web server, wherein the at least one client device includes a browser that is operative responsive at least in part to the instructions to cause the display device to output the graphical user interface via at least one web page, wherein the instructions include markup language instructions.

4. The apparatus according to claim 2, further comprising the at least one client device.

5. The apparatus according to claim 1, further comprising the at least one client device, wherein the at least one client device includes the at least one processor.

6. The apparatus according to claim 5, wherein the at least one processor includes a graphics processor, wherein the instructions include video graphics signals generated by the graphics processor.

7. The apparatus according to claim 6, wherein the at least one client device includes a mobile phone, wherein the mobile phone includes the at least one processor and at least one software application, wherein the at last one software application is operative in the at least one processor to cause the display device to output the graphical user interface.

8. The apparatus according to claim 1, wherein the at least one processor is operative to communicate the data representative of the appointment via causing an e-mail message to be sent through at least one e-mail server, which e-mail message includes the scheduling data and a listing of each of the products included in the appointment cart list.

9. The apparatus according to claim 1, wherein the at least one processor is operative to communicate the data representative of the appointment to at least one server that is operative to enable at least a portion of the data representative of the appointment to be displayed on a point of sale terminal operated by the vendor.

10. The apparatus according to claim 1, wherein the at least one processor is operative to communicate the data representative of the appointment to at least one calendar server that is operative to store a plurality of different appointments.

11. The apparatus according to claim 1, wherein the plurality of graphical user interface elements include a graphical user interface element that includes a listing of a plurality of names of persons that are requestable to attend the appointment and show the products included in the appointment cart list to the user, wherein the scheduling data further includes data representative of a name of a person selected from the listing of names, which person is requested to show the products included in the appointment cart list.

12. The apparatus according to claim 9, wherein the plurality of graphical user interface elements include a graphical user interface element that includes a listing of a plurality of store locations at which the appointment can be scheduled to show the products included in the appointment cart list, wherein the scheduling data further includes data representative of a store location selected from the listing of store locations.

13. The apparatus according to claim 1, wherein the at least one processor is operatively configured to provide instructions for the at least one client device that cause the at least one client device to cause the graphical user interface to simultaneously display a plurality of cart adding selectable options, including a shopping cart selectable option and the appointment cart selectable option, wherein the at least one processor is operative responsive at least in part to selections of one or more products and is responsive at least in part to at least one selection of the shopping cart selectable option through operation of the at least one input device, to cause data representative of the selected one or more products to be added to a shopping cart list stored in the at least one data store, wherein the at least one processor is operative to cause payment data to be associated with the products included in the shopping cart list.

14. The apparatus according to claim 13, wherein the at least one processor is operatively configured to provide instructions for the at least one client device that cause the at least one client device to cause the graphical user interface to separately display: data representative of each of the products stored in the shopping cart list; and data representative of each of the products stored in the appointment cart list.

15. The apparatus according to claim 14, wherein the at least one processor is operatively configured to provide instructions for the at least one client device that cause the at least one client device to cause the graphical user interface to display a plurality of cart viewing selection options, including a shopping cart viewing selection option and an appointment cart viewing selection option,
wherein the at least one processor is operatively configured to provide instructions for the at least one client device that cause the at least one client device to cause the graphical user interface to display data representative of each of the products stored in the shopping cart list responsive at least in part to a selection of the shopping cart viewing selection option through operation of the at least one input device, and
wherein the at least one processor is operatively configured to provide instructions for the at least one client device that cause the at least one client device to cause the graphical user interface to display data representative of each of the products stored in the appointment cart list responsive at least in part to a selection of the appointment cart viewing selection option through operation of the at least one input device.

16. The apparatus according to claim 13, further comprising at least one server and the at least one data store, wherein the at least one server is in operative connection with the at least one data store, wherein the at least one server includes the at least one processor,
wherein the at least one server is operative to receive payment data from the at least one client device associated with the products listed in the shopping cart list and is operative to receive shipping address data from the at least one client device,
wherein the at least one server is operative responsive at least in part to the payment data to cause the products listed in the shopping cart list to be delivered to a postal address associated with the address data;
wherein the at least one processor is operative to communicate the data representative of the appointment without requiring data representative of a payment for the purchase of the products listed in the appointment cart list to be provided to the at least one server.

17. A non-transitory computer readable media bearing computer executable instructions that when executed in at least one processor are operative to cause the at least one processor to carry out a method,
wherein the at least one processor is operative to communicate with at least one client device and at least one data store,
wherein the at least one client device includes a display device and at least one input device capable of being operated by a user,
wherein the method comprises:
a) through operation of at least one processor, providing instructions for the at least one client device that cause the at least one client device to output through the display device a graphical user interface,
wherein the graphical user interface displays one or more products that can be selected through operation of the at least one input device of the at least one client device,
wherein the graphical user interface displays at least one cart adding selectable option, including an appointment cart selectable option,
b) through operation of at least one processor responsive at least in part to selections of one or more products and responsive at least in part to at least one selection of the appointment cart selectable option through operation of the at least one input device, causing data representative of the one or more selected products to be added to an appointment cart list stored in the at least one data store,
c) through operation of at least one processor, receiving data representative of a date and at least one time for scheduling an appointment and user identifying data,
d) through operation of at least one processor, causing the appointment to be scheduled for the user to view in-person each of the products included in the appointment cart list on the date and at least one time received in (c), including through operation of at least one processor communicating data representative of the date and the at least one time of the scheduled appointment, the user identifying data, and a listing of each of the products included in the appointment cart list to a vendor.

18. The non-transitory computer readable media according to claim 17, wherein in (b) the graphical user interface simultaneously displays a plurality of cart adding selectable options, including a shopping cart selectable option and the appointment cart selectable option,
further comprising:
e) through operation of at least one processor responsive at least in part to selections of one or more products and responsive at least in part to at least one selection of the shopping cart selectable option through operation of the at least one input device, causing data representative of the selected one or more products to be added to a shopping cart list stored in the at least one data store,
f) through operation of at least one processor, causing payment data to be associated with the products included in the shopping cart list.

19. The non-transitory computer readable media according to claim 17, wherein (d) includes through operation of at least one processor causing an e-mail message to be sent through at least one e-mail server, which e-mail message includes the data representative of the date and the at least one time of the scheduled appointment and a listing of each of the products included in the appointment cart list.

20. The non-transitory computer readable media according to claim 17, wherein (d) includes at least one of:
through operation of the at least one processor, causing a calendar server to store the appointment for the data and the at least one time received in (c);
through operation of the at least one processor, causing at least one point of sale terminal to display the data representative of the date and the at least one time of the scheduled appointment and a listing of each of the products included in the appointment cart list;
or any combination thereof.
